(19) United States
(12) Patent Application Publication
(10) Pub. No.: US 2026/0207980 A1
(43) Pub. Date: Jul. 23, 2026

(54) Aerial Drone-Based Fire Suppression Sheet Deployment System and Method

(71) Applicant: Sang Ho Moon, New York, NY (US)

(72) Inventor: Sang Ho Moon, New York, NY (US)

(21) Appl. No.: 19/445,503

(22) Filed: Jan. 10, 2026

Related U.S. Application Data
(60) Provisional application No. 63/746,548, filed on Jan. 17, 2025.

(51) Int. Cl. A62C 3/02

(52) U.S. Cl. CPC A62C 3/0228; A62C 3/0257

(57) ABSTRACT

A fire suppression system includes a plurality of aerial drones configured to carry, deploy, and release a fire suppression sheet over a target fire area. The fire suppression sheet is transported in a folded state and unfolded in midair as the aerial drones move apart. In certain embodiments, the fire suppression sheet includes a vent hole configured to reduce upward airflow during descent. The system enables scalable deployment by selecting a size of the fire suppression sheet and a number of aerial drones based on the size of the target fire area and allows sequential deployment of multiple fire suppression sheets.

### TECHNICAL FIELD

The present disclosure relates to fire suppression systems, and more particularly, to systems and methods for deploying fire suppression sheets using aerial drones.

### BACKGROUND

Wildfires present significant challenges due to their rapid spread and difficulty of access in remote or rugged terrain.

Conventional aerial firefighting techniques, such as water or retardant drops,
often suffer from inefficiency, limited precision, and environmental impact.
Accordingly, there is a need for improved fire suppression approaches that provide targeted deployment, reduced environmental residue, and enhanced operational flexibility.

### SUMMARY

The present disclosure provides a fire suppression system utilizing

a plurality of aerial drones to transport, deploy, and release a fire suppression sheet
over a target fire area. The fire suppression sheet is carried in a folded state and
unfolded in midair as the aerial drones move apart.

In certain embodiments, the fire suppression sheet includes

a vent hole configured to reduce upward airflow during descent.
The system allows for scalable deployment based on the size of the target fire area
and enables sequential deployment of multiple fire suppression sheets.

### BRIEF DESCRIPTION OF THE DRAWINGS

For purposes of clarity and consistency, the following reference numerals are used throughout the drawings and the detailed description.

Aerial drones are generally designated by reference numeral 100.
A fire suppression sheet is designated by reference numeral 110.
Suspension lines coupling the fire suppression sheet to the aerial drones are designated
by reference numeral 120.
A vent hole formed in the fire suppression sheet is designated by reference numeral 130.

FIG. 1 illustrates a plurality of aerial drones carrying a folded fire suppression sheet.

FIG. 2 illustrates the fire suppression sheet during an unfolding stage as the aerial drones move apart.

FIG. 3 illustrates the fire suppression sheet in a fully deployed configuration supported

by the aerial drones prior to release.

FIG. 4 illustrates the fire suppression sheet released from the aerial drones and descending toward a target fire area.

### DETAILED DESCRIPTION

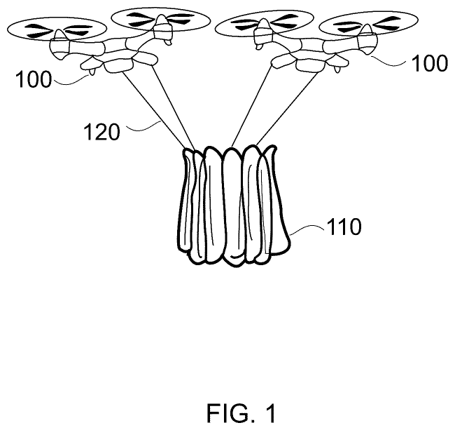

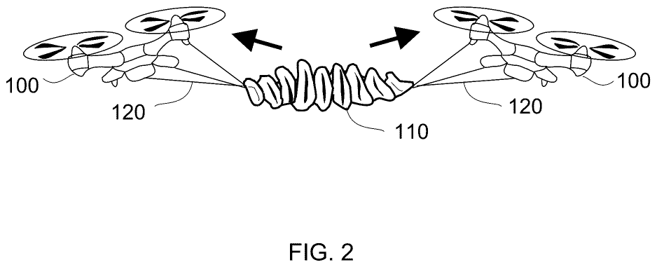

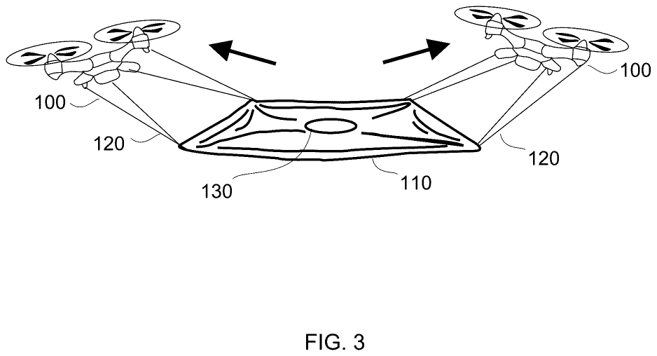

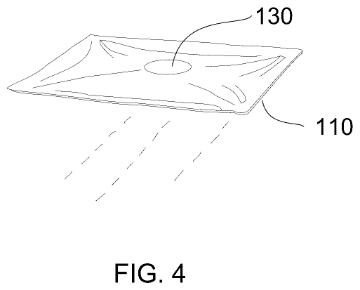

Referring to FIGS. 1-4, a fire suppression system includes a plurality of aerial drones 100 configured to cooperatively carry, deploy, and release a fire suppression sheet 110. The aerial drones 100 may operate together to transport the fire suppression sheet 110 toward a target fire area.

The fire suppression sheet 110 is initially transported in a folded configuration and is coupled to the aerial drones 100 by a plurality of suspension lines 120. The suspension lines 120 are configured to support the fire suppression sheet 110 during transport and deployment.

As the aerial drones 100 move away from one another while maintaining tension in the suspension lines 120, the fire suppression sheet 110 unfolds in midair, transitioning from the folded configuration to a fully deployed configuration. In certain embodiments, the unfolding of the fire suppression sheet 110 occurs in an accordion-like manner as the aerial drones 100 separate from one another.

In the fully deployed configuration, the fire suppression sheet 110 may remain supported by the aerial drones 100 prior to release. In this state, the suspension lines 120 may remain under tension to maintain the fire suppression sheet 110 in an extended and stable configuration.

The fire suppression sheet 110 may include a vent hole 130 positioned centrally within the sheet. The vent hole 130 is configured to reduce upward airflow during descent of the fire suppression sheet 110, thereby improving deployment stability as the fire suppression sheet 110 descends toward the target fire area.

After deployment, the fire suppression sheet 110 is released from the aerial drones 100 and descends toward the target fire area. The fire suppression sheet 110 may be configured to land over or near an active fire to suppress flames, limit oxygen supply, or otherwise mitigate fire spread.

The size of the fire suppression sheet 110 and the number of aerial drones 100 may be selected based on the size and characteristics of the target fire area. For larger or more complex fire areas, a greater number of aerial drones 100 or a larger fire suppression sheet 110 may be employed.

In some embodiments, multiple fire suppression sheets 110 may be sequentially deployed to address larger fire areas or to provide sustained fire suppression coverage over time.

In some embodiments, a plurality of aerial drones 100 may be organized into multiple groups, wherein different groups of aerial drones 100 are sequentially deployed to deliver and release fire suppression sheets 110 toward a target fire area. [0014] In such embodiments, one group of aerial drones 100 may release a fire suppression sheet 110 while one or more other groups of aerial drones 100 remain on standby or are subsequently deployed, thereby enabling continuous or staggered fire suppression operations without requiring reuse of the same aerial drones.

In certain embodiments, the fire suppression sheet 110 is formed from an environmentally degradable, fire-resistant material. The fire suppression sheet 110 may further include a thin surface coating configured to enhance fire suppression performance while minimizing added weight.

### Additional Embodiments of Fire Suppression Sheet

In certain embodiments, the fire suppression sheet 110 may comprise a fire-resistant textile, composite, or layered material configured to withstand high temperatures encountered in wildfire environments. The sheet may be formed from woven, nonwoven, or laminated materials, including environmentally degradable materials.

In some embodiments, the fire suppression sheet 110 may be configured to absorb, retain, or be coated with a fire suppression agent, such as a liquid, gel, foam, or retardant substance. The fire suppression agent may be released upon deployment or upon contact with a target fire area to enhance fire suppression effectiveness.

In certain embodiments, the fire suppression sheet, including any absorbed or retained fire suppression agent, may be transported and deployed by one or more high-payload aerial drones configured to support increased load weight, without limitation to a specific drone size or power output.

1. A fire suppression system comprising:
a plurality of aerial drones; and
a fire suppression sheet configured to be carried in a folded state by the plurality of aerial drones, wherein the plurality of aerial drones are configured to move apart in midair to unfold the fire suppression sheet prior to releasing the fire suppression sheet toward a target fire area.

2. The system of claim 1, wherein the fire suppression sheet is unfolded as the plurality of aerial drones move away from one another.

3. The system of claim 1, wherein the fire suppression sheet is unfolded in an accordion-like configuration during deployment.

4. The system of claim 1, wherein the fire suppression sheet is fully deployed while being supported by the plurality of aerial drones prior to release.

5. The system of claim 1, wherein the fire suppression sheet includes a vent hole.

6. The system of claim 5, wherein the vent hole is configured to reduce upward airflow during descent of the fire suppression sheet.

7. The system of claim 1, wherein the fire suppression sheet is released from the plurality of aerial drones after being unfolded.

8. The system of claim 1, wherein the fire suppression sheet is coupled to the plurality of aerial drones by suspension lines connected to respective portions of the fire suppression sheet.

9. The system of claim 1, wherein two or more aerial drones cooperatively carry and deploy the fire suppression sheet.

10. The system of claim 1, wherein a size of the fire suppression sheet and a number of the plurality of aerial drones are selected based on a size and characteristics of a target fire area.

11. The system of claim 1, wherein multiple fire suppression sheets are sequentially deployed toward the target fire area.

12. A method of suppressing a fire, comprising:
carrying a folded fire suppression sheet using a plurality of aerial drones;
moving the plurality of aerial drones apart from one another to unfold the fire suppression sheet in midair; and
releasing the fire suppression sheet toward a target fire area.
